(19) United States
(12) Patent Application Publication
(10) Pub. No.: US 2007/0287940 A1
(43) Pub. Date: Dec. 13, 2007

(54) Device for caressing the body

(75) Inventors: Irving Sabo, Milton, VT (US); Aaron J. Goldberg, Burlington, VT (US)

Correspondence Address: Thomas G. Ference, 38 Thasha Lane #C6, Essex Junction, VT, 05452-4508, US

(73) Assignee: BOWS, LLC

(21) Appl. No.: 11/448,264

(22) Filed: Jun. 7, 2006

(51) Int. Cl. A61H 1/00

(52) U.S. Cl. 601/137; 601/72

(57) ABSTRACT

A device for caressing an anatomical portion of the body comprising a substantially rigid element and a flexible strip with opposed distal ends. The distal ends are connected to the rigid element at separate locations providing a gap between the rigid element and the flexible strip. The flexible strip comprises a textured surface facing away from the rigid element. The flexible strip is at least partially tensioned to place it in a springy state that conforms to the body and creates a soothing and stimulating sensation when stroked against the body.

### FIELD OF THE INVENTION

This invention relates to a hand-held device for caressing an anatomical portion of a body. In particular, the present invention is directed to the use of a mounted flexible strip to provide a soothing and stimulating sensation when stroked against the body.

### BACKGROUND OF THE INVENTION

Numerous hand-held massage and sensory stimulation device have been developed over the years. These devices usually employ the use of an apparatus having a structure for contact with the body and then pressing, rolling, frictioning or vibrating that structure across the surface of the body. The structure generates a pleasurable sensation as it is moved across the skin and muscles providing a therapeutic effect on the body. As varied as these devices are, the human body is able to sense, differentiate and respond to the unique sensations each device produces. A significant degree of aesthetic appeal and visual stimulation may also be associated with the design of each device. It is therefore apparent to those skilled in the art that opportunity exists for further enhancement of the sensory stimulation effects, aesthetic appeal and structural design of these devices.

### SUMMARY OF THE INVENTION

One aspect of the present invention is directed to a device for caressing the body, comprising a substantially rigid element and a flexible strip with opposed distal ends. The distal ends are connected to the rigid element at separate locations providing a gap between the rigid element and the flexible strip.

A second aspect of the present invention is directed to a device for caressing the body, comprising a substantially rigid element and a strip connected to the rigid element at two locations. A gap exists between the rigid element and the strip between the two locations. The strip includes at least one material from the group consisting of a unitary and a woven material.

A third aspect of the present invention is directed to a device for caressing the body, comprising a substantially rigid element and a strip connected to the rigid element at two locations. A gap exists between the rigid element and the strip between the two locations. The strip includes a first material and a second material mounted to the first material.

A fourth aspect of the present invention is directed to a device for caressing the body, comprising a substantially rigid element and a convex strip connected to the rigid element at two locations. A gap exists between the rigid element and the convex strip between the two locations.

A fifth aspect of the present invention is directed to a device for caressing the body, comprising a substantially rigid element and a plurality of strips connected to the rigid element. Each of the plurality of strips connected at two locations. A gap exists between the rigid element and each of the strips between the two locations.

A sixth aspect of the present invention is directed to a device for caressing the body, comprising a substantially rigid element and a plurality of flexible elements connected to the rigid element. Each of the plurality of flexible elements connected at two separate locations to the rigid element. A first gap exists between flexible elements of the plurality of flexible elements and a second gap exists between the rigid element and the flexible elements between the two locations.

A seventh aspect of the present invention is directed to a device for caressing the body, comprising a substantially rigid element and a flexible strip with first and second opposed distal ends. The first distal end connected to the rigid element, the second distal end not connected to the rigid element, and the flexible strip bowing way from the rigid element.

An eighth aspect of the present invention is directed to a device for caressing the body, comprising a unitary structure including a substantially rigid element at a first end and a flexible strip at the opposite end. The unitary structure bends back upon itself to generate a gap between the rigid element and the flexible strip.

### BRIEF DESCRIPTION OF DRAWINGS

The foregoing and other aspects and advantages of the invention will be apparent from the following detailed description of the invention, as illustrated in the accompanying drawings, in which:

FIG. 1a is a perspective view of one embodiment of a massage device illustrating the rigid element and flexible strip portions of the device;

FIG. 1b is a front side view of the massage device in FIG. 1a;

FIG. 1c is a top side view of the massage device in FIG. 1a;

FIG. 1d is a bottom side view of the massage device in FIG. 1a;

FIG. 1e is a left side view of the massage device in FIG. 1a;

FIG. 1f is a right side view of the massage device in FIG. 1a;

FIG. 2a is a perspective view of another embodiment of a massage device according to the present invention;

FIG. 2b is a bottom side view of the massage device in FIG. 2a;

FIG. 2c is a front side view of the massage device in FIG. 2a;

FIG. 3a is a perspective view of another embodiment of a massage device illustrating an alternative way of fabricating the rigid element and flexible strip portions of the device;

FIG. 3b is a bottom side view of the massage device in FIG. 3a;

FIG. 3c is a left side view of the massage device in FIG. 3a;

FIG. 3d is a punched pattern of heat moldable material prior to fabrication into a rigid member as depicted in FIG. 3a.

FIG. 3e is a punched pattern of heat moldable material prior to fabrication into a flexible strip as depicted in FIG. 3a.

FIG. 4a is a perspective view of yet another embodiment of a massage device illustrating an alternative way of fabricating the rigid element and flexible strip portions of the device;

FIG. 4b is a plan view illustrating the massage device in FIG. 4a in an extended state prior to final assembly;

FIG. 5a is a perspective view of another embodiment of a massage device comprising a plurality of cords that make up the flexible strip portion of the massage device.

FIG. 5b is a front side view of the massage device in FIG. 5a;

FIG. 5c is a bottom side view of the massage device in FIG. 5a;

FIG. 5d is an enlarged, perspective view of the left end of the massage device in FIG. 5a showing the mechanism by which tension is adjusted in the flexible strip;

FIG. 5e is an enlarged, front side view of the left end of the massage device in FIG. 5a;

FIG. 6a is a perspective view of another embodiment of the present invention showing incorporation of a vibrating means with the massage device;

FIG. 6b is a front side, sectional view of the massage device in FIG. 6a;

FIG. 6c is a top side, sectional view of the massage device in FIG. 6a;

FIG. 7a is a perspective view of an embodiment of the present invention that incorporates multiple flexible strips attached to an elongated rigid element;

FIG. 7b is a plan view of a flexible strip prior to attachment to the elongated rigid element in FIG. 7a;

FIG. 7c is a front side, partial sectional view of the massage device in FIG. 7a;

FIG. 7d is a top side view of the massage device in FIG. 7a;

FIG. 7e is a bottom side, sectional view of the massage device in FIG. 7a;

FIG. 8a is a perspective view of another embodiment of the present invention that incorporates multiple flexible strips attached to a rigid element;

FIG. 8b is a plan view of a flexible strip prior to attachment to the rigid element in FIG. 8a;

FIG. 8c is a front side, partial sectional view of the massage device in FIG. 8a;

FIG. 8d is a top side view of the massage device in FIG. 8a; and

FIG. 8e is a bottom, sectional view of the massage device in FIG. 8a.

FIG. 9a is a perspective view of another embodiment of the present invention with only one end of the flexible strip connected to the rigid element.

FIG. 9b is a top side view of the massage device illustrated in FIG. 9a.

### DETAILED DESCRIPTION OF THE INVENTION

The present invention is aimed at providing a hand-held device to caress the body that creates a soothing and stimulating effect. The device is used against the skin in a stroking or strumming motion as when playing a violin, cello or other string instrument.

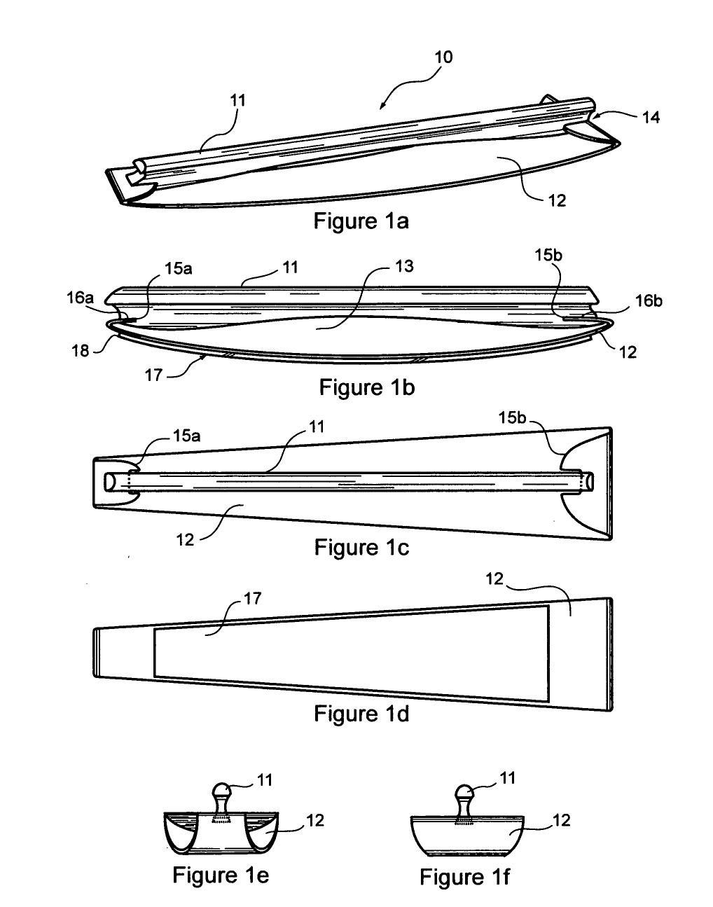

FIGS. 1a-1f illustrate one embodiment of caressing device 10. It comprises a substantially rigid element 11 and a flexible strip 12. Rigid element 11 may be elongated and take the form of a bow or baton. Rigid element 11 functions as a handle for the user. Rigid element 11 may be fabricated from wood, metal, plastic or composite materials. Flexible strip 12 is mounted at two locations to rigid element 11 so that a gap 13 is generated between the flexible strip and rigid element between these two locations. Flexible strip 12 comprises a unitary element consisting of a unitary material or a woven material. Flexible strip 12 may be formed from a variety of thin flexible materials such as styrene, other plastics, spring metal and the like.

Flexible strip 12 is mounted to rigid element 11 by way of connections 14. Flexible strip 12 possesses opposed distal ends 15a and 15b. First distal end 15a and second distal end 15b are connected at separate locations to rigid element 11 to form gap 13. In this embodiment, connections 14 occur at opposite ends of rigid element 11. First distal end 15a of flexible strip 12 fits into a notch 16a in one end of rigid element 11 while second distal end 15b fits into a notch 16b at the other end of the rigid element. Numerous other methods of connecting flexible strip 12 to rigid element 11 exist in the art. These may include screwing, stapling, hinging, gluing, etc. Connections 14 may be removable or permanent.

Flexible strip 12 may have a textured surface 17 on the surface facing away from the rigid element 11. The texturing may exist over the whole surface 17 or just a portion thereof. The textured surface 17 may be created by texturing the surface of the material that flexible strip 12 is made out of, or mounting another textured material 18 to the flexible strip. Some examples of textured materials 18 that may be attached are silk, leather, microfiber and fur. These textured materials 18 may be attached by VELCRO®, adhesive, double stick tape or the like and can be removable and reusable.

Flexible strip 12 is at least partially tensioned so as to have a springy quality when pressure is placed upon its outward facing surface. This tensioning may occur through the manner in which the strip is formed or in how it is connected to rigid element 11. For example, as illustrated in FIG. 1b, flexible strip 12 may bow away from rigid member 11 providing a convex outer surface. Flexible strip may also vary in width along its length as illustrated in FIG. 1d and 1c.

To use caressing device 10, the user holds rigid member 11 in his or her hand. Flexible strip 12 is then placed in contact with the surface of the body and an appropriate amount of force applied. The flexibility of strip 12, combined with the springiness generated by tension in the strip, allows the strip to conform to the body's surface. The device is then moved against the skin in a stroking or strumming motion. As flexible strip 12 is moved over the surface of the body it generates a pleasurable sensation providing a therapeutic effect on the body. The addition of the textured surface 17 can be used to vary the desired sensations device 10 can produce. Modifying such parameters as the width, thickness, stiffness, material and length of flexible strip 12 can also change the sensations generated.

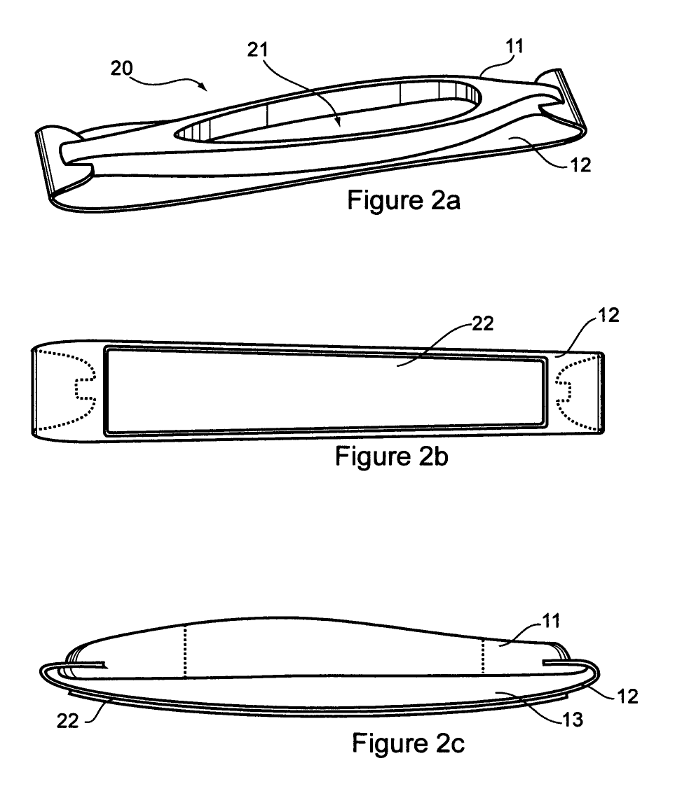

FIGS. 2a-2c illustrate another embodiment of a caressing device 20. In this device, substantially rigid member 10 has been modified from the previous embodiment. It has been widened and provided with opening 21 in the center. Opening 21 may allow the user to place a finger(s) through the handle into gap 13 and press on the back surface of flexible strip 12 as it is being used to caress the body. The pressure of the user's finger(s) can then be used to modify the sensation generated by the device, allowing for specific pressure points to be achieved.

In this embodiment another feature of the caressing device is disclosed. As illustrated in FIG. 2c, flexible strip 12 comprises a porous textured material 22 attached to the surface facing away from rigid element 11. Textured porous material 22 can hold a quantity of fluid or cream to be applied to the body. Porous textured material 22 may be a sponge, fabric or other porous thin material. The fluid may be at least one from the group of an oil, a cream, a lubricant, an ointment and a medicinally beneficial compound.

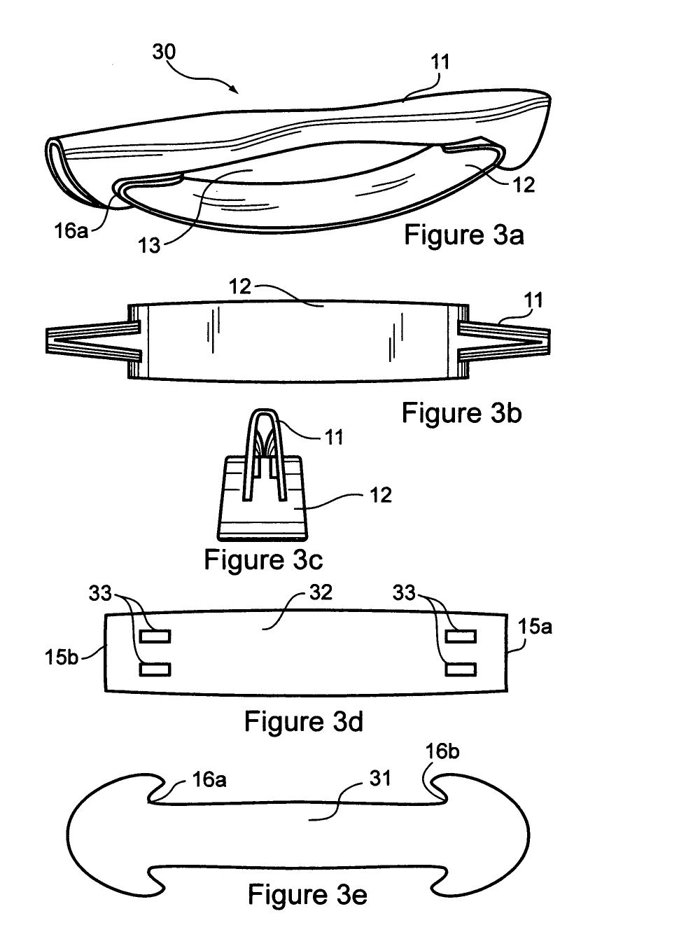

FIGS. 3a-3e illustrate another embodiment of a caressing device 30. This embodiment provides for an inexpensive way to manufacture a caressing device 30 comprising a substantially rigid element 11 and flexible strip 12. Both components are fabricated from the same material. As an example 0.040-inch thick styrene sheet may be used. However, any heat formable, flexible material may be used. Rigid element pattern 31 and flexible strip pattern 32 are punched from the styrene sheet. Rigid element pattern 31 is then heated to soften it, folded along its length and bent at its center point to create rigid element 11. The structure left after cooling is now a substantially rigid element created from an originally flexible sheet. Flexible strip pattern 32 can be heated and folded over at its distal ends 15. Upon cooling this structure is still a flexible strip 12. Flexible strip 12 is then mounted using grooved holes 33 and fitting them with notches 16 of substantially rigid element 11. Flexible strip 12 bows outward from rigid element 11 creating gap 13. Flexible strip 12 is now at least partially tensioned. Other methods of forming both a substantially rigid element 11 and flexible strip 12 from the same piece of material may include using chemicals or light to alter the structural properties of different regions of the material to obtain rigid and flexible portions. Injection molding can also be used to generate a single material structure with flexible portion and rigid portions.

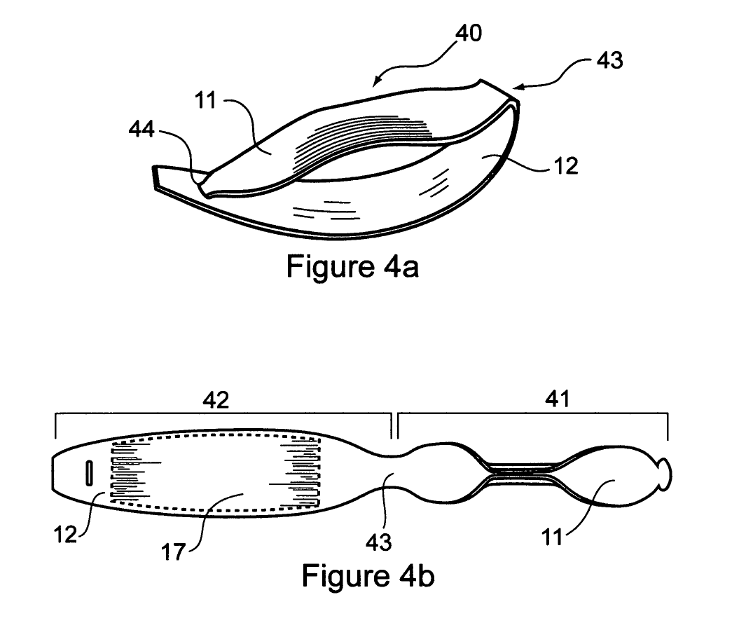

FIGS. 4a and 4b illustrate still another embodiment for an inexpensive way to manufacture a caressing device 40. As in the previous embodiment the device 40 may be manufactured from 0.040-inch thick styrene. Here a single pattern is punched and then formed through heat. The result is a deformed section 41 that is the rigid element 11 and an undeformed section 42 that is a flexible strip 12. These two sections are integrally connected at joint 43 and removably connected at interconnection 44. A textured surface 17 may be created on the surface of section 42. Alternatively, a textured and/or porous material may be adhered to section 42.

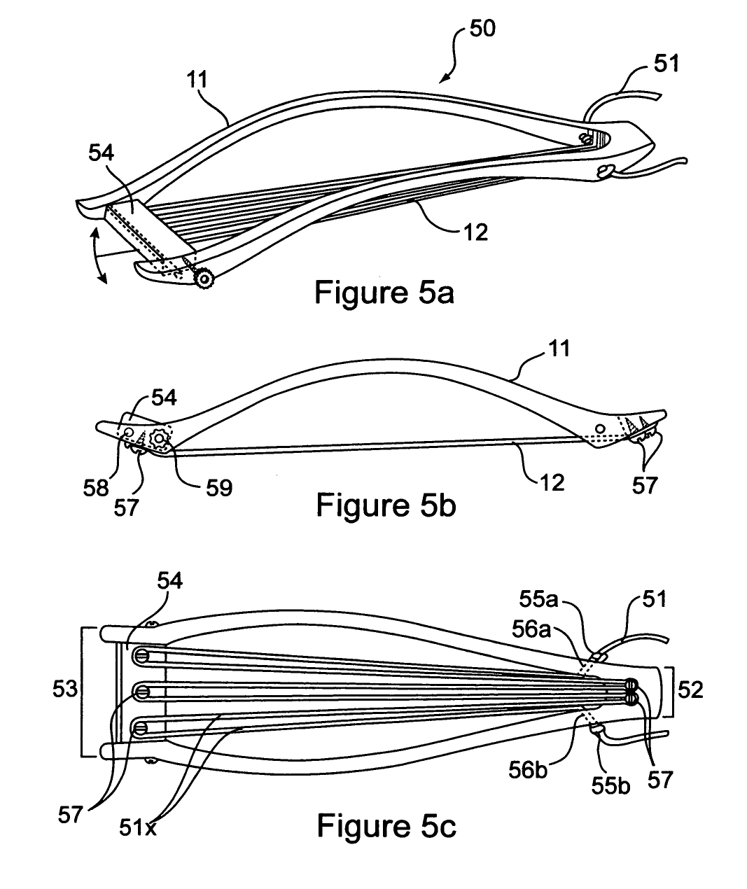

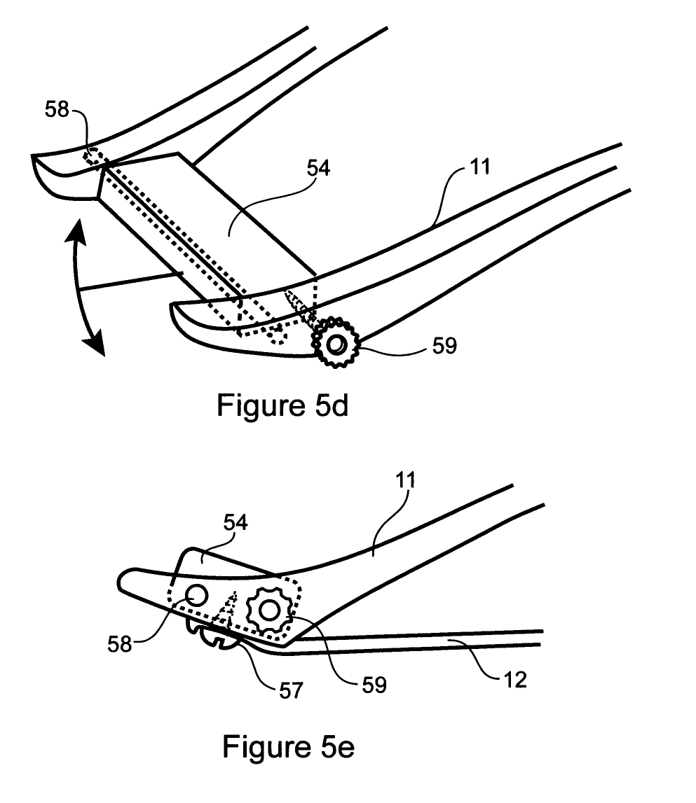

FIGS. 5a-5e illustrate another embodiment of a caressing device 50. In this embodiment flexible strip 12 is comprised of a plurality of flexible elements. For example, flexible strip 12 may be created from a cord 51 that is woven back and forth between the two ends of substantially rigid element 11. Cord 51 is preferably nylon covered in silk, but other textured natural and synthetic cord materials may be used. Rigid element 11 is forked with a narrow end 52 and a wide end 53. Between the forks at wide end 53 is located tensioning block 54. Tensioning block 54 is used to adjust the tension exerted on the plurality of elements or cord segments 51x that make up flexible strip 12. Adjusting the tension of cord segments 51x adjusts the manner in which these segments conform to the body and also the sensations they produce.

Cord 51 has a knot 55a at one end. Cord 51 is threaded through hole 56a in narrow end 52 of rigid element 11. Cord 51 loops around alternating screws 57 between tensioning block 54 and narrow end 52. Cord 51 is brought through hole 56b in narrow end 52. A second knot 55b is created to secure cord 51.

Tensioning block 52 may be a rectangular block with an offset shaft 58 that runs between the two forks at wide end 53 of rigid element 11. Tensioning block 52 can be rotated around shaft 58 to adjust the amount of tension on cord segments 51x. Once the desired tension is obtained, lock screw 59 is used to set that tension.

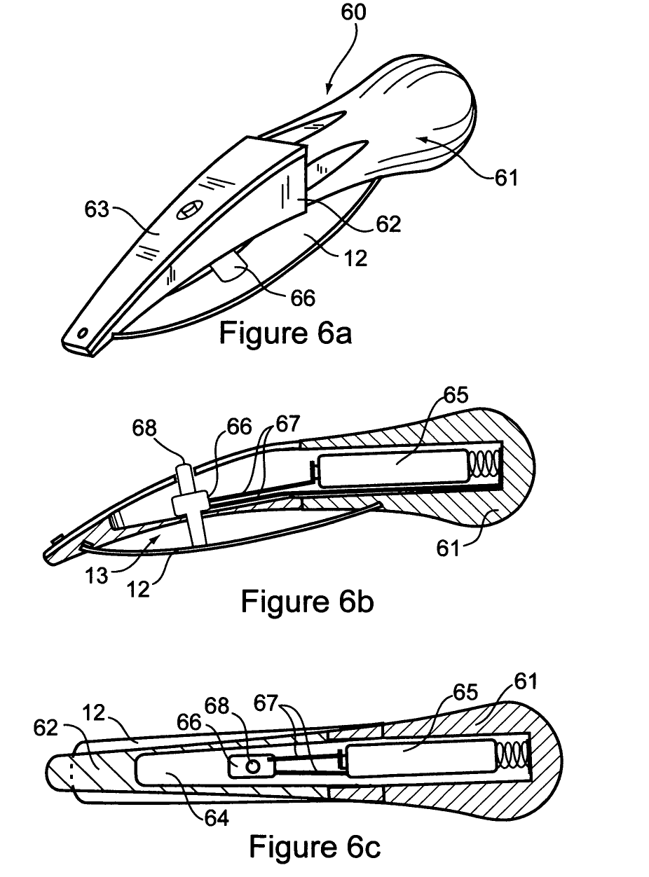

FIGS. 6a-c illustrate still another embodiment of a caressing device 60. In this embodiment electronics are incorporated to enhance the tactile sensation produced by the device. Rigid element 11 of device 60 may be fabricated as several parts. The parts may include a handle 61, a housing 62 and a cover 63 for access to the inside of the housing. Together these parts create a cavity 64 in which the electronics are contained. Within cavity 64 may reside a power source 65, an electronic vibration device 66, electrical connections 67 and a switch 68 to activate and deactivate the electronics. Flexible strip 12 is mounted to rigid element 11 providing a gap 13. Flexible strip 12 may be permanently mounted to rigid element 11 or it may be connected in a manner in which it can be removed or replaced. Vibration device 66 is mounted to rigid element 11 and makes connection with flexible strip 12.

As switch 68 is activated, electronic vibration device 66 starts vibrating. Vibrations are transmitted to flexible strip 12 from the vibration device 66. These vibrations are transmitted throughout flexible strip 12. The material properties and dimensions of flexible strip 12, along with the frequency of vibration device 66, determine the vibrational modes of the flexible strip. As flexible strip 12 is pressed and moved across the body, the vibration of the flexible strip enhance the tactile sensation imparted to the body. Further electronics may be included in device 60 to adjust the amplitude and frequency of the vibrations and have them correlate with the stroking motion of the user.

Alternatively, or in addition to the vibrating electronics, device 60 may also include a miniature acoustical system to provide for auditory stimulation when using the device. The miniature acoustical system may include electronics such as a power source, speakers, and a radio or MP3 player. The miniature acoustical system would reside within cavity 64 and have openings in rigid element 12 to emit sound. Music would come preloaded or the user could transfer their own music to the device. If both the vibrating electronics and miniature acoustical system are combined, additional electronics with a controller maybe provided to synchronize the vibrations to beats of the music.

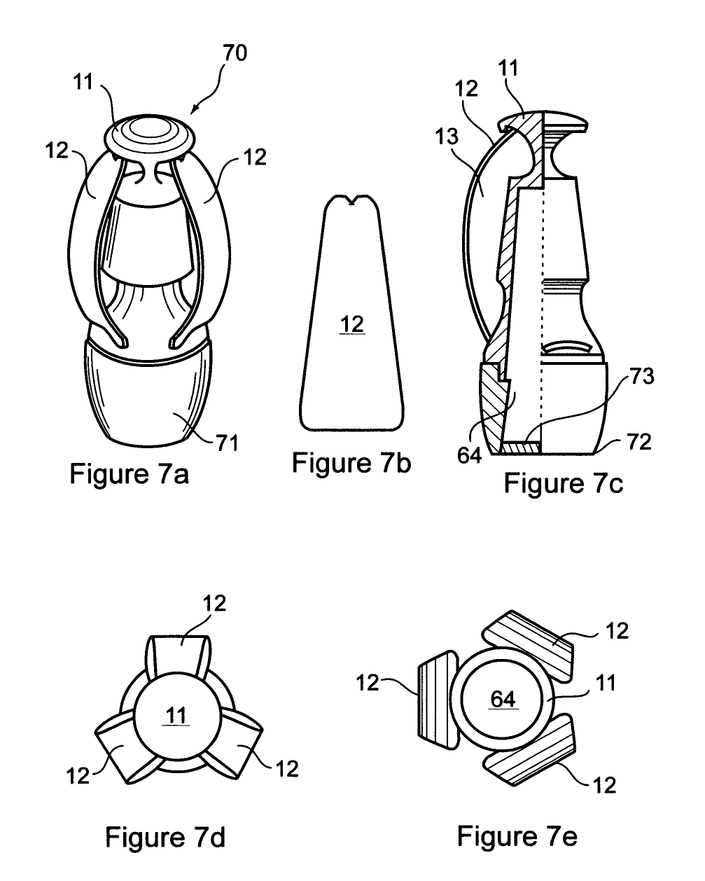

FIGS. 7a-c illustrate yet another embodiment of a caressing device 70. Device 70 has several features. First, rigid element 11 is elongated and designed to sit upright on one end. Second, it has a plurality of flexible strips 12 connected lengthwise around the long axis of rigid element 11. The opposed distal ends of each flexible strip 12 are connected to rigid element 11 at separate locations providing a gap between the flexible strip and the rigid element. Each flexible strip 12 may bow away from rigid element 11 and reside in a tensioned state. In another feature, the connections of flexible strips 12 are shifted towards one end of elongated rigid element 11 to provide for a handle 71 at the other end. Texturing or a textured material may be applied to the outer surface of each flexible strip.

Device 70 is used in a similar manner to the previously described embodiments. The user grasps handle 71 and places one of flexible strips 12 upon the body. The device is then moved against the skin in a stroking or strumming motion. As flexible strip 12 is moved over the surface of the body it generates a pleasurable sensation providing a therapeutic effect on the body. A further advantage of the multiples flexible strips 12 arranged around rigid element 11 is that each strip can have different tactile properties so that the user may choose different sensations to be applied to the body without having to change the flexible strips or reach for another device.

FIG. 7c illustrates how this embodiment may also be adapted to include the electronics for creating vibrations or music as described in the previous embodiment. The electronics may reside within cavity 64. Access to cavity 64 is provided through base 72 of device 60. A cap 73 is used to seal the cavity.

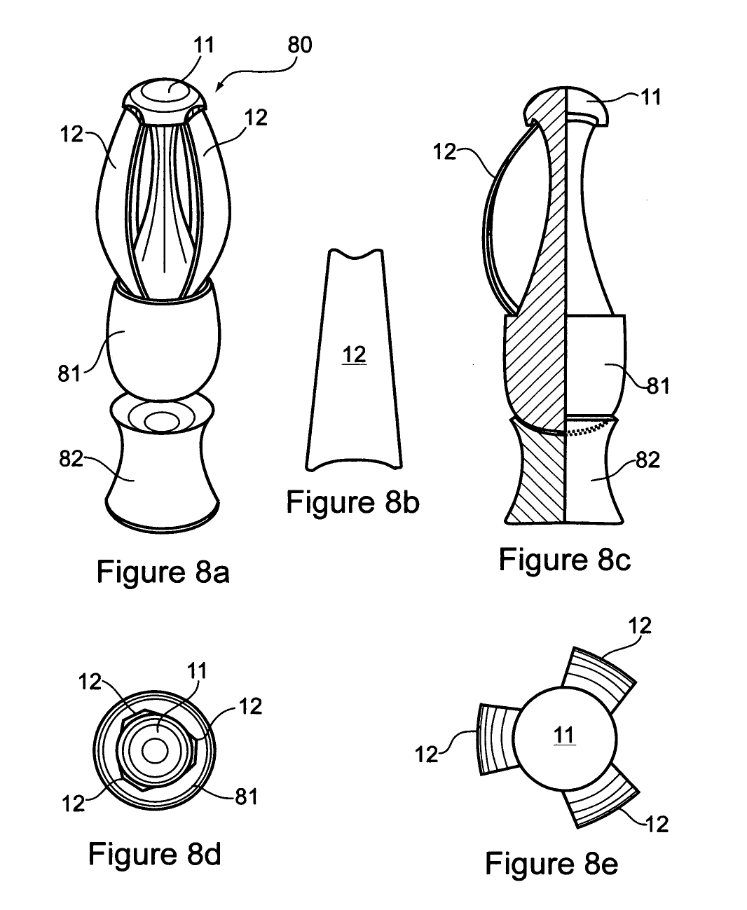

FIGS. 8a-c illustrate yet another embodiment of a caressing device 80. Device 80 is similar to device 70 in that it has multiple flexible strips 12 arranged around the long axis of elongated rigid element 11. However, instead of having a flat based handle, it has a round based handle 81 that sets within a holder 82. With this design, device 80 may still be placed upright and free standing upon a table when not in use; however, it possesses the ergonomics associated with a round handle when being used.

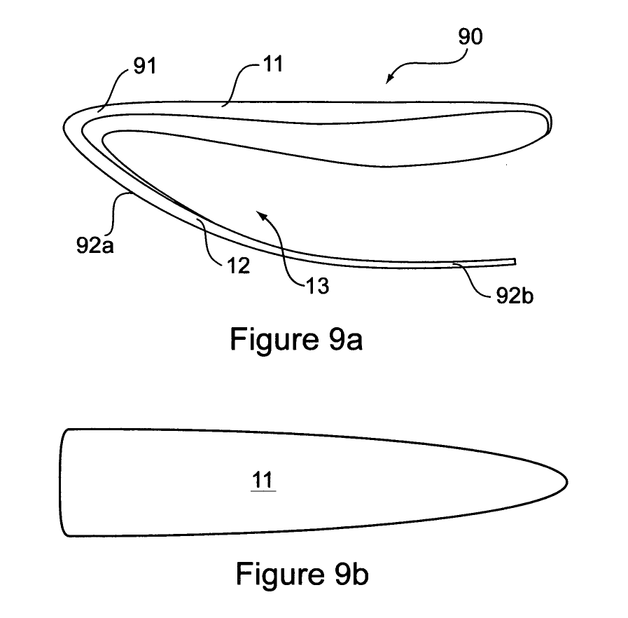

FIGS. 9a and 9b illustrate still another embodiment of caressing device 90. Device 90 may be a unitary device fabricated from a single piece of material. The unitary structure comprises a substantially rigid element 11 that turns into a flexible strip 12. The unitary structure bends back upon itself to generate a gap 13 between rigid element 11 and flexible strip 12. Flexible element 12 may have different levels of flexibility along its length. At location 92a it may be more rigid than location 92b. Injection molding is one method of fabricating such a device. By changing various parameters such as material thickness or adding ridged structures to the different cavities of the mold, both rigid and flexible portions of device 90 may be created out of the same material.

Alternatively, device 90 may be fabricated in pieces, a separate substantially rigid element and a separate flexible strip. The flexible strip having first and second opposed distal ends with only the first distal end connected to the rigid element, the second distal end not being connected to the rigid element. The flexible strip bows away from the rigid element creating a gap.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1) A device for caressing the body, comprising:
a) a substantially rigid element;
b) a flexible strip with opposed distal ends; and
c) said distal ends connected to said rigid element at separate locations providing a gap between said rigid element and said flexible strip;

2) A device as recited in claim 1, wherein said flexible strip is comprised of a unitary element.

3) A device as recited in claim 1, wherein said flexible strip comprises a surface facing away from said rigid element.

4) A device as recited in claim 3, wherein said surface is textured.

5) A device as recited in claim 3, further comprising a material attached to said surface.

6) A device as recited in claim 5, wherein said material is a textured material.

7) A device as recited in claim 6, wherein said material is porous and can hold a quantity of fluid to be applied to the body.

8) A device as recited in claim 7, wherein said fluid is at least one from the group of an oil, a cream, a lubricant, an ointment and a medicinally beneficial compound.

9) A device as recited in claim 1, wherein at least a portion of said flexible strip is tensioned to provide a resilient force when placed upon the body.

10) A device as recited in claim 1, wherein said flexible strip bows away from said rigid element.

11) A device as recited in claim 1, wherein the width of said flexible strip varies along its length.

12) A device as recited in claim 1, wherein when said flexible strip is placed in contact with the body said flexible strip conforms to the body.

13) A device as recited in claim 12, wherein when said flexible strip is moved over the surface of the body said flexible strip vibrates.

14) A device as recited in claim 12, wherein when said flexible strip is moved over the surface of the body said flexible strip provides a soothing and stimulating sensation.

15) A device as recited in claim 1, wherein said rigid element is elongated.

16) A device as recited in claim 1, wherein said rigid element extends beyond the length of said flexible strip to form a handle.

17) A device as recited in claim 1, further comprising a vibration device for vibrating said flexible strip.

18) A device as recited in claim 17, wherein said vibration device is an electronic vibration device.

19) A device as recited in claim 17, wherein said vibration device transmits vibrations to said flexible strip.

20) A device as recited in claim 18, wherein said vibration device adjust vibrations with the stroking motion of said flexible strip as it passes over the body.

21) A device as recited in claim 1, further comprising an acoustical device.

22) A device as recited in claim 21, wherein said acoustical device adjusts sound relative to the stroking motion of said flexible strip as it passes over the body.

23) A device for caressing the body, comprising;
a) a substantially rigid element; and
b) a strip connected to said rigid element at two locations, a gap between said rigid element and said strip between said two locations, wherein said strip includes at least one from the group consisting of a unitary material and a woven material.

24) A device for caressing the body, comprising:
a) a substantially rigid element; and
b) a strip connected to said rigid element at two locations, a gap between said rigid element and said strip between said two locations, wherein said strip includes a first material and a second material mounted to said first material.

25) A device for caressing the body, comprising:
a) a substantially rigid element; and
b) a convex strip connected to said rigid element at two locations, a gap between said rigid element and said convex strip between said two locations.

26) A device for caressing the body, comprising:
a) a substantially rigid element; and
b) a plurality of strips connected to said rigid element, each of said plurality of strips connected at two locations, a gap between said rigid element and each of said strips between said two locations.

27) A device as recited in claim 26, wherein said rigid element has an axis along its length and said plurality of strips connected lengthwise around said axis.

28) A device for caressing the body, comprising:
a) a substantially rigid element; and
b) a plurality of flexible elements connected to said rigid element, each of said plurality of flexible elements connected at two separate locations to said rigid element, a first gap between flexible elements of said plurality of flexible elements, a second gap between said rigid element and said flexible elements between said two locations.

29) A device as recited in claim 28, wherein each said flexible element is a flexible cord.

30) A device as recited in claim 29, wherein each said flexible cord is covered by a textured material.

31) A device as recited in claim 28, further comprising a tensioning block for adjusting the tension on said flexible elements.

32) A device for caressing the body, comprising:
a) a substantially rigid element;
b) a flexible strip with first and second opposed distal ends; and
c) said first and second distal ends connected to said rigid element at separate locations providing a gap between said rigid element and said flexible strip.

33) A device as recited in claim 32, wherein said flexible strip is connected by removable connections at said first and second distal ends.

34) A device as recited in claim 32, wherein said flexible strip is integrally connected with said rigid element at said first distal end and removably connected at said second distal end.

35) A device as recited in claim 34, wherein rigid element and said flexible strip are constructed from a single piece of material.

36) A device for caressing the body, comprising:
a) a substantially rigid element; and
b) a flexible strip with first and second opposed distal ends, said first distal end connected to said rigid element, said second distal end not connected to said rigid element, and said flexible strip bowing way from said rigid element.

37) A device for caressing the body, comprising: a unitary structure including a substantially rigid element at a first end,and a flexible strip at the opposite end, said unitary structure bends back upon itself to generate a gap between said rigid element and said flexible strip.
